(19) United States
(12) Patent Application Publication
(10) Pub. No.: US 2011/0312320 A1
(43) Pub. Date: Dec. 22, 2011

(54) SATELLITE-ASSISTED POSITIONING IN HYBRID TERRESTRIAL-SATELLITE COMMUNICATION SYSTEMS

(75) Inventor: Mark Leo Moeglein, Ashland, OR (US)

(73) Assignee: QUALCOMM Incorporated, San Diego, CA (US)

(21) Appl. No.: 13/161,224

(22) Filed: Jun. 15, 2011

Related U.S. Application Data
(60) Provisional application No. 61/355,348, filed on Jun. 16, 2010.

(51) Int. Cl. H04W 64/00; H04W 56/00

(52) U.S. Cl. 455/426.1; 455/427

(57) ABSTRACT

Mobile device positioning includes a mobile device receiving a prompt to discover its position. In response to this prompt, the mobile device searches for communication signals between the mobile device and one of the communication satellites of the hybrid terrestrial-satellite communication system. If such signals are found, the mobile device accesses a communication satellite almanac to retrieve a location associated with the coverage area of the satellite spot beam in which the mobile device is currently located. Using this coverage area location information, the mobile device may access a satellite positioning system to obtain more accurate position data.

### CLAIM OF PRIORITY UNDER 35 U.S.C. §119

The present application for patent claims priority to Provisional Application No. 61/355,348 entitled “SATELLITE-ASSISTED POSITIONING IN HYBRID TERRESTRIAL-SATELLITE COMMUNICATION SYSTEMS”, filed Jun. 16, 2010, and assigned to the assignee hereof and hereby expressly incorporated by reference herein.

### TECHNICAL FIELD

The present teachings relate, in general, to hybrid terrestrial and satellite communication systems and, more particularly, to satellite-assisted mobile device positioning in such hybrid terrestrial and satellite communication systems.

### BACKGROUND

The majority of wireless communications in operation today are provided by various types of wireless wide area networks (WWANs). These wireless communication networks may be implemented using a cellular network configuration. A cellular network is a radio network made up of a number of cells each served by at least one fixed-location transceiver known as a base station transceiver (BTS), access node (AN), node B, e-node B (eNB), or the like. This fixed-location transceiver is part of a base station that provides the communication hub. Each cell has a limited range of coverage, such that a number of base stations are used to cover a wide geographic area.

It is often beneficial to determine the position or location of a mobile device, which may be referred to as an access terminal (AT), mobile station (MS), or the like. Position information may be used by the user and/or by the network or carrier. Position capability may also be required by governmental regulation in order to accommodate emergency services provided by police, emergency medical personnel, and fire fighters. Centralized emergency networks, such as the 9-1-1 system in the United States often rely on position information, which, while readily available for landline communications, can be more challenging for devices in wireless communication networks.

One common method used for a mobile device to obtain position information is by leveraging the location data for base stations and other types of terrestrial transmitters. Each base station typically has an identifier (ID) that specifically identifies that particular base station. Carrier networks will often create a list of base stations which includes at least the geographic position of the base station along with its ID. The list may also contain related information such as the approximate coverage area for the base station, the supported channels, and the like. The list of this information is referred to as a base station almanac. In a typical operation, a mobile device would attempt to obtain position information by first obtaining or determining the base station ID through the signals that it receives from that base station. The base station ID is generally included as an administrative portion of the signal overhead. The mobile device would then access the almanac, which may be (at least partially) maintained on the mobile device or available for access by the mobile device, to look up the base station location information using the base station ID. The base station location information can be information indicative of the position of the base station, information indicative of a position associated with the base station (such as cell sector center of a serving cell sector in a sectorized base station), and/or other information related to the position of the base station.

The location information in the base station almanac can be used in a number of ways. For example, the base station position itself may be used as a coarse position for the mobile device, since it is generally within 5-10 km of the mobile device. In some implementations, a coarse position may be used in conjunction with a different positioning technique; for example, a coarse position may be used to increase the efficiency of satellite acquisition for satellite positioning.

In another example, signals from base stations or other terrestrial transmitters may be used to determine a more precise position than the coarse position described above. For example, mobile device position may be determined using a technique that determines a time between transmission and receipt of a signal to and/or from a base station. One well-known technique is advanced forward link trilateration (AFLT). AFLT is a technique that computes the location of the mobile device from the mobile device's measured time of arrival of radio signals from a number of base stations. AFLT-enabled mobile devices take various data measurements regarding the signal delay from the transmitting base stations, signal strength measurements, and the like to calculate the estimated mobile device position.

Additional positioning techniques based on one or more transmission times include Enhanced Observed Time Difference (E-OTD), Uplink Time Difference of Arrival (U-TDOA), Observed Time Difference of Arrival (OTDOA), and the like. The mobile device may determine its position directly using the transmission time information, or may send information to the network to have the position determined using one or more network resources (which may also use other position information such as satellite positioning information). Terrestrial positioning techniques may be used in combination with satellite positioning techniques, which is an example of a hybrid positioning system (a system that uses more than one positioning technique).

Satellite positioning systems (SPS) generally use the properties of known satellite signals in order to calculate estimated positions on the surface of the Earth. The global positioning system (GPS) is an SPS operated by the United States. An SPS typically includes a system of satellite-based transmitters positioned to enable entities to determine their location on or above the Earth based, at least in part, on signals received from the transmitters. In a particular example, such transmitters may be located on Earth orbiting satellite vehicles (SVs). For example, an SV in a constellation of a global navigation satellite system (GNSS), such as GPS, Galileo, Glonass or Compass, may transmit a signal marked with a PN code that is distinguishable from PN codes transmitted by other SVs in the constellation (e.g., using different PN codes for each satellite as in GPS or using the same code on different frequencies as in Glonass). Additionally, such transmitters may be in regional satellite navigational systems, such as the proposed Beidou system in China, the proposed Indian Regional Navigation Satellite System (IRNSS) in India, and the proposed Quasi-Zenith Satellite System (QZSS) in Japan.

SPS, such as the GPS, generally use a constellation of between approximately 24 and 32 medium Earth orbit satellites that transmit precise radio frequency (RF) signals that allow GPS receivers to determine their current location, the time, and their velocity. A GPS receiver is able to calculate its position by carefully timing the signals sent by three or preferably four or more of the constellation of GPS satellites. In addition to the PN code, each GPS satellite continually transmits messages containing the time the message was sent, a precise orbit for the satellite sending the message, i.e., the ephemeris, and the general system health and rough orbit estimates of all of the GPS satellites, i.e., the satellite almanac. The receiver uses the arrival time of each signal to measure the distance to each satellite (referred to as a pseudorange to reflect some uncertainty in the measurement). The GPS receiver also uses, when appropriate, the knowledge that the GPS receiver is on or near the surface of a sphere representative of the Earth. This information is then used to estimate the position of the GPS receiver as the intersection of the sphere surfaces. The resulting coordinates are often converted to a more convenient form for the user, such as latitude and longitude, or location on a map, and then either displayed in some visual format or provided to a compatible application for further processing.

In addition to use in SPSs, satellites have also been used to implement satellite communication systems. While satellites have been used in backend or backbone communication transmissions for many years, use for personal communication systems has only more recently been implemented. In such satellite systems, a satellite phone or satellite communication device acts as a type of mobile phone that connects to orbiting satellites instead of terrestrial cell sites. Depending on the architecture of a particular system, coverage may include the entire Earth, or only specific regions.

Satellite communication systems have generally failed to enjoy the same type of success experienced by terrestrial wireless communication systems, likely due to the large initial start up costs for the communication companies to deploy the requisite number of satellites into orbit and, for the user, because of the relatively high costs of the associated mobile devices, as well as high usage costs, sometimes adding up to several U.S. dollars per minute. However, as wireless technology has advanced, it has become more feasible to share mobile hardware for processing both terrestrial and satellite communications. Hybrid terrestrial-satellite communication systems have been suggested that will provide for a mobile phone or device to use terrestrial base stations when practical, but switch to satellite stations as a backup when the mobile phone or device is no longer able to reliably couple to the terrestrial base station. While technology advancements have made such a hybrid system more feasible, there are still numerous issues to account for in blending the use of the two different types of systems.

### SUMMARY

The various embodiments of the present teachings are directed to satellite-assisted positioning of mobile devices configured for satellite communications; for example, for mobile devices in a hybrid terrestrial-satellite communication system. A position operation is initiated at a mobile device (for example, in response to user or application initiation, or in response to network initiation). In response, the mobile device searches for communication-related signals between the mobile device and one of the communication satellites of the hybrid terrestrial-satellite communication system. If such signals of a certain pre-defined signal strength exist, the mobile device accesses a satellite almanac to retrieve a location associated with a coverage area of the satellite spot beam in which the mobile device is currently located. Using this coverage area location information and any uncertainty information, the mobile device may access an SPS to obtain more accurate position data.

Representative embodiments of the present teachings are directed to methods for positioning a mobile station in a hybrid terrestrial-satellite communication system. These methods include the mobile station searching for a communication signal sent by at least one communication satellite of the hybrid terrestrial-satellite communication system and determining an initial location of the mobile station in response to detection of the communication signal and based on a location of a coverage area within which the mobile station is located. The coverage area is formed by a spot beam transmitted by the communication satellite. The methods also include the mobile station searching for an SPS signal in response to detection of the SPS signal by using the initial location and determining information indicative of a position of the mobile station using positioning signals from the SPS signal.

Further representative embodiments of the present teachings are directed to mobile devices that include a processor, a modem coupled to the processor, a transceiver coupled to the processor, an antenna array coupled to the transceiver, a storage memory coupled to the processor, and a signal analysis module stored on the storage memory. When executed by the processor in responsive to a request for a position of the mobile device, the signal analysis module configures the mobile device to search for a communication signal from a communication satellite. The mobile device also includes a mobile device positioning module stored on the storage memory. When executed by the processor in response to detection of the communication signal, the mobile device positioning module configures the mobile device to access a communication satellite almanac for location information relating to a coverage area in which the mobile device is located and that is associated with the communication signal. The coverage area is formed by a spot beam transmitted from the communication satellite. The mobile device also includes an SPS processing module stored on the storage memory. When executed by the processor in response to detection of an SPS signal using the location information, the SPS processing module configures the mobile device to determine information indicative of the position using positioning signals detected from the SPS signal.

Additional representative embodiments of the present teachings are directed to computer-readable media including program code stored thereon. This program code includes code, executable at a mobile station, to search for a communication signal from at least one communication satellite of a hybrid terrestrial-satellite communication system, and code, executable responsive to detection of the communication signal, to determine an initial location of the mobile station based on a location of a coverage area within which the mobile station is located. The coverage area is created by a spot beam transmitted from the at least one communication satellite. The program code also includes code, executable at the mobile station, to search for an SPS signal using the initial location, and code, executable in response to detection of the SPS signal, to determine information indicative of a position of the mobile station using positioning signals from the SPS signal.

Still further representative embodiments of the present teachings are directed to systems for positioning a mobile station in a hybrid terrestrial-satellite communication system. These systems include means, executable at the mobile station, for searching for a communication signal from least one communication satellite of the hybrid terrestrial-satellite communication system and means, executable responsive to detection of the communication signal, for determining an initial location of the mobile station based on a location of a coverage area within which the mobile station is located. The coverage area is created by a spot beam transmitted from the at least one communication satellite. The systems also include means, executable at the mobile station, for searching for an SPS signal using the initial location and means, executable in response to detection of the SPS signal, for determining information indicative of a position of the mobile station using positioning signals from the SPS signal.

The foregoing has outlined rather broadly the features and technical advantages of the present teachings in order that the detailed description that follows may be better understood. Additional features and advantages will be described hereinafter which form the subject of the claims. It should be appreciated by those skilled in the art that the conception and specific embodiments disclosed may be readily utilized as a basis for modifying or designing other structures for carrying out the same purposes of the present teachings. It should also be realized by those skilled in the art that such equivalent constructions do not depart from the technology of the present teachings as set forth in the appended claims. The novel features which are believed to be characteristic of the teachings, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present teachings.

### BRIEF DESCRIPTION OF THE DRAWINGS

For a more complete understanding of the present teachings, reference is now made to the following description taken in conjunction with the accompanying drawings.

FIG. 1 is a block diagram illustrating a satellite communication network.

FIG. 2 is a block diagram illustrating a hybrid terrestrial-satellite communication system.

FIG. 3 is an operational block diagram illustrating example operational blocks related to implementation of one embodiment of the present teachings.

FIG. 4 is a block diagram illustrating a mobile station (MS).

FIG. 5 illustrates an exemplary computer system which may be employed to implement the base stations and their operations therein.

### DETAILED DESCRIPTION

Satellite communications systems typically operate two-way communications through a series of spot beams formed by the communication satellite antennas. For purposes of the teachings described herein, the term “communication satellite” will mean those satellites that facilitate or provide two-way communications, such as the communication satellites in satellite communications systems like Globalstar, Inc.'s GLOBALSTAR™, Iridium Satellite, LLC's IRIDIUM™, the maritime satellite communications system (MARSAT), and the like. The spot beams transmitted from these communication satellites are aimed to create a particular coverage area on the surface of the Earth. These communication satellites use multiple directional antennas to form the beams intended to intersect a specific coverage area. The coverage area of each spot beam depends on the type of antenna and the beam forming technology used. Depending on the particular type of orbit the communication satellite is in, the coverage area of the spot beam may also vary with time, as the spot beam sweeps over the Earth with the movement of the satellite, or may be relatively stationary for satellites in a geostationary orbit. In either instance, a spot beam may correspond to a coverage area between approximately 70 and 100 miles in diameter.

When a satellite moves in a geostationary orbit, the coverage area of the spot beam remains relatively fixed on a specific location on the Earth's surface; however, the circumference of the coverage area may vary slightly over time in normal situations, due to the movement of the satellite, signal drop off, atmospheric anomalies, or the like. For satellites that move in other types of orbits, such as geosynchronous orbits or non-geosynchronous orbits (e.g., low-earth orbit (LEO), medium-earth orbit (MEO), and the like), the coverage area of the spot beam will move across the surface of the Earth in relation to the satellite orbit. Logic in place for the satellites' directional antennas may also cause the spot beam to vary over time according to a pre-designed pattern or to result in an irregularly-shaped beam. Such patterns and shapes may be designed to accommodate particular geographic ground features, physical traffic patterns, communication load patterns, and the like.

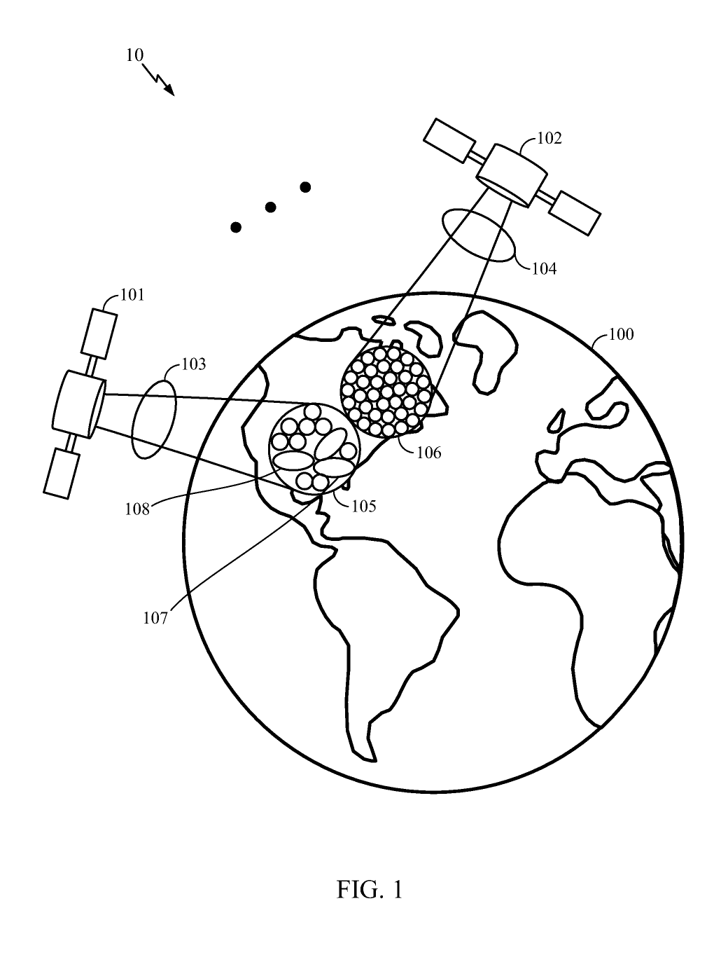

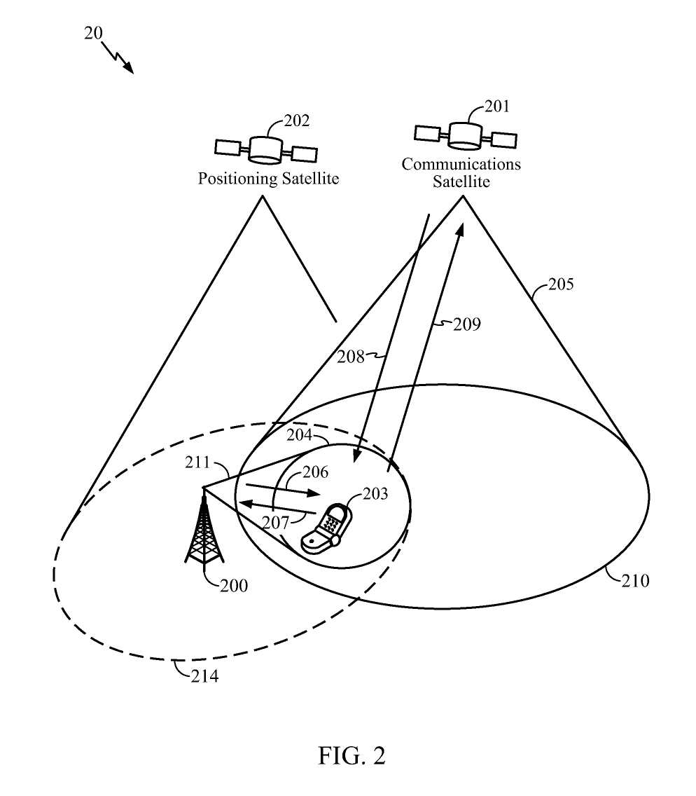

Turning now to FIG. 1, a block diagram is shown illustrating a satellite communication network 10 in which an embodiment of the present teachings may be employed. The satellite communication network 10 is the satellite portion of a hybrid terrestrial-satellite communication system (hybrid terrestrial-satellite communication system) 20 (FIG. 2). In providing two-way communication access, a constellation of communication satellites, including the satellites 101 and 102, transmit multiple spot beams 103 and 104, respectively to the surface of the Earth 100. Each one of the multiple spot beams 103 and 104 creates its own coverage area within beam windows 105 and 106. A beam window is the sum of all coverage areas formed by the multiple spot beams transmitted from a particular satellite. For example, the beam window 105 is the sum of the multiple spot beams 103 transmitted by satellite 101. The coverage areas of each individual spot beam may be formed into uniform or near uniform circles or, through beam formation technology, formed into irregularly-shaped coverage areas, such as the irregular coverage areas 107 and 108 within the beam window 105. Similarly, the multiple spot beams 103 and 104 may be configured within the beam windows 105 and 106 to provide even coverage areas throughout the beam window, such as in the beam window 106, or to provide targeted customized coverage areas within the beam window, such as in the beam window 105, which leaves gaps within some of the coverage areas, for reasons such as geographical terrain, population distribution, and the like.

FIG. 2 is a block diagram illustrating the hybrid terrestrial-satellite communication system 20 configured according to one embodiment of the present teachings. The hybrid terrestrial-satellite communication system 20 includes multiple access nodes arranged in such a manner so as to provide multiple adjacent terrestrial cells defined by multiple, geographically spaced terrestrial base stations in addition to multiple access spot beam coverage areas provided by multiple orbiting satellites. The hybrid terrestrial-satellite communication system 20 facilitates two-way communications between parties on the Earth's surface. The illustrated portion of the hybrid terrestrial-satellite communication system 20 in FIG. 2 presents only one of the many terrestrial base stations making up the hybrid terrestrial-satellite communication system 20, i.e., the terrestrial base station 200, and only one of the many orbiting satellites making up the hybrid terrestrial-satellite communication system 20, i.e., the communication satellite 201. FIG. 2 also includes a positioning satellite 202, which is one of several satellites that make up a separate SPS. The SPS operates in parallel with the hybrid terrestrial-satellite communication system 20 and, even though it is a part of this separate SPS, the signals from the positioning satellite 202 may be used for positioning and/or to provide information to the hybrid terrestrial-satellite communication system 20. Note that although FIG. 2 shows positioning satellite 202 and communications satellite 201 at similar distances from the earth's surface (for ease of illustration), positioning satellites and communications satellites may be in the same or different orbit types (with associated elevations about the surface of the earth).

It should be noted that the positioning satellite 202 may be any of the various types of satellite used in an SPS. For example, it may be used in a GNSS, such as the GPS, Galileo, or Glonass systems, or in a regional positioning system, such as the Beidou, IRNSS, and QZSS proposed regional systems.

It should further be noted that the positioning satellite 202 transmits positioning information (generally a navigation message containing time data, satellite position data, etc.), as well as a PN code to be correlated with an internally generated code on a mobile device to perform positioning operations, but does not receive and transmit communication signals from mobile devices. In contrast, like terrestrial wireless communication systems, the communication satellite 201 is a satellite configured to process two-way communications. For purposes of the teachings herein, positioning satellites and communication satellites are two separate and distinct types of satellites in orbit.

The terrestrial base station 200 may operate in a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE) network, and the like. A CDMA network may implement one or more radio access technologies (RATs) such as Telecommunications Industry Association's CDMA2000®, Wideband-CDMA (W-CDMA), and the like. CDMA2000® includes the interim standards (ISs) IS-95, IS-2000, and IS-856. A TDMA network may implement Global System for Mobile Communications (GSM), Digital Advanced Mobile Phone System (D-AMPS), or some other RAT. GSM and W-CDMA are described in publicly available documents from the 3rd Generation Partnership Project (3GPP) consortium. CDMA2000® is likewise described in publicly available documents from the 3rd Generation Partnership Project 2 (3GPP2) consortium.

In an example operation, a user of a mobile device, such as the mobile station 203, may initially be located within a coverage area 204 of the base station 200. The base station 200 forms a radio frequency (RF) beam 211 that creates the coverage area 204 that the mobile station 203 is in. Forward link (FL) communications occur between the base station 200 and the mobile station 203 via a FL 206, while reverse link (RL) communications occur between the base station 200 and the mobile station 203 via a RL 207. If, for some reason, the mobile station 203 is no longer able to send or receive signals with the base station 200, the mobile station 203 will attempt to establish communications with another terrestrial base station (not shown). Likewise, if a neighboring base station is stronger than the current serving base station, the base station 200, the hybrid terrestrial-satellite network 20 may instruct the mobile station 203 to use the stronger base station. Should the mobile station 203 fail to establish a connection with any terrestrial base station, i.e., it is out of terrestrial coverage areas, it switches communication operations over to the satellite portion of the hybrid terrestrial-satellite communication system 20.

The communication satellite 201 generates multiple spot beams with each spot beam covering a particular area (e.g., 210, 214) on the surface of the Earth that moves in relation to the movement of the communication satellite 201 in its orbit. The mobile station 203 is located within a coverage area 210 of one such spot beam 205. When connection to the terrestrial portion of the hybrid terrestrial-satellite communication system 20 cannot be established, the mobile station 203 searches for any communication satellite signals within the range of its antenna. As it lies within the coverage area 210 of the spot beam 205, it detects the satellite communication FL signals broadcast over the FL 208 and returns RL communication information over the RL 209. The user of the mobile station 203 may then continue to communicate as before, although, with system accommodations made for the differences in roundtrip signal timing.

When a positioning operation for the mobile station 203 is initiated, the mobile station may obtain at least some assistance information regardless of whether communication is being implemented using the terrestrial system by connecting through the base station 200 or using the satellite system by connecting through the communication satellite 201. If communication is occurring with the base station 200, the mobile station 203 may obtain its coarse location information from a base station almanac for the hybrid terrestrial-satellite communication system 20. It may use this information to narrow further search windows and it may use it as an input to navigation algorithms. These algorithms may make use of coverage area information and/or phase information for a multilateration process (e.g., AFLT, E-OTD, U-TDOA, OTDOA, or the like), or, if a satellite signal is available through the SPS, either through separate SPS processing or an assisted-SPS process.

If, however, communication is occurring with the communication satellite 201, positioning logic within the mobile station 203 can initiate a positioning technique using communication satellite almanac information to determine a coarse location for the mobile station 203. In this case, the mobile station 203 accesses a communication satellite almanac, which includes at least the known locations associated with each coverage area of the applicable spot beams, and uses the location corresponding to the coverage area 210 as the initial location for purposes of obtaining a fix on the positioning satellites and positioning signals within the SPS that will be used to determine a more accurate mobile position. The communication satellite almanac will include the known coverage area locations depending on the type of communication satellites being used. It may also include satellite position and clock bias models, as a function of time, similar those used in SPS systems. For example, when a particular satellite is in a geostationary orbit, the location will generally be a fixed location. When the satellite is not in geostationary orbit, the location of the coverage area is time dependent, in which case the location information in the communication satellite almanac will give a location related to the time. Thus, when the mobile station 203 accesses the information in the communication satellite almanac, it will use the current time and find the location of the coverage area it is in along with the ID of the particular spot beam that is creating the coverage area. The almanac may contain information used to determine the spot beam characteristics, such as satellite antenna patterns, position, velocity, attitude, etc. vs. time. The communication satellite almanac may be stored in a memory on the mobile station 203, or it may be stored at a remote location accessible by the mobile station 203, such as the base station 200, satellite 201, or the like.

Currently, the concept of an almanac is used for existing SPS systems and for terrestrial systems. The use of base station almanac in positioning is described above. However, temporal position information for satellites is more complex, since they are orbiting the earth rather than remaining stationary at the earth's surface. For SPS systems, the term “almanac” is generally used to refer to information regarding the rough orbits of each of the positioning satellites in the system, and can be obtained from the terrestrial network, or can be obtained from a satellite navigation message (e.g., for the GPS system the entire almanac can be obtained from 12.5 minutes of the demodulated navigation message). In the GPS system, each satellite also transmits its own satellite ephemeris data, which provides very precise orbital information.

After the mobile station 203 obtains an initial coarse position using the communication satellite almanac, it would then access a positional satellite almanac to determine which candidate positioning satellites may be in view at the initial rough position and current time. For candidate positioning satellites, the coarse position, estimated uncertainty in the coarse position, and the satellite orbit information (e.g. almanac and/or ephemeris) can be used to determine a code phase search window based on an approximate distance between the mobile device and the candidate positioning satellite. For example, mobile station 203 may use a particular location in the coverage area as the coarse location (e.g., the center of the coverage area at the current time), and may use the coverage area to provide an uncertainty in the coarse position (e.g., the distance between the particular location selected for use as the coarse position and the location on the boundary of the coverage area farthest from that location). The coarse position may be used to determine the center of the search window, while the uncertainty can be used to determine limits of the search window for the search in code space for the signals from the satellites expected to be in view. The position uncertainty (as well as time and/or frequency uncertainty information) can also be used to search in frequency space, since the signals from the satellites are in general Doppler shifted from the nominal values due to relative motion between the mobile device and the satellite. Example techniques for code phase and frequency searching are described in detail elsewhere.

In some embodiments, communication satellite almanac information may be integrated with one or more other types of almanac information. For example, the communication satellite almanac can include positional satellite almanac information and/or terrestrial, base station almanac information.

It should further be noted that the illustrations depicted in FIG. 2 are not to scale. The coverage area of a base station, such as base station 200, is usually less than 10 miles, while the diameter of a coverage area of a spot beam is usually greater than 10 miles.

As used herein, a mobile station refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WIFI™, or other network, and regardless of whether satellite signal reception, assistance data reception, and/or position-related processing occurs at the device, at a server, or at another device associated with the network. Any operable combination of the above are also considered a “mobile station.”

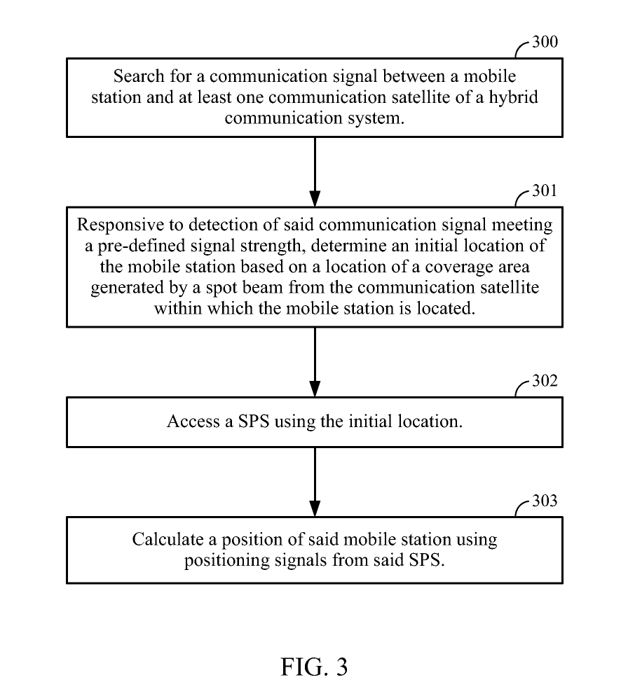

FIG. 3 is an operational block diagram illustrating example operational blocks related to implementation of one embodiment of the present teachings that may be used for positioning of a mobile device that does not have access to coarse position information from terrestrial transmitters (e.g., it is in an area without service or where it is unable to obtain coarse position information even if it can receive signals from terrestrial transmitter(s)). In block 300, a communication signal is searched for by the mobile station between the mobile station and at least one of the communication satellites. This may be performed either in response to initiation of a location request, or in order to initiate communication using the communication satellite system. An initial coarse location of the mobile station is determined, in block 301, based on a location of the coverage area generated by the satellite's spot beam within which the mobile station is located. The mobile station accesses a SPS, in block 302, using the initial location, and determines position information (e.g., determines pseudoranges to one or more positioning satellites and then sends the pseudoranges to a network resource to calculate its position, or calculates its position at the mobile station), in block 303, using signals from the SPS.

In recent years, SPS receivers have been integrated into terrestrial wireless communication devices. In such devices, position information for the device may be obtained through the SPS system, either using the SPS systems as a separate system completely, or in an assisted, combined system where initial location information is gathered by the mobile station, such as through a base station almanac, AFLT, E-OTD, U-TDOA, OTDOA, or the like, and this initial location information is then used for a faster acquisition of the SPS signals. However, in these types of existing combined wireless-SPS systems, the communication aspect of the mobile station occurs through the typical terrestrial wireless communication hardware while a separate, SPS receiver is included for accessing the separate and independent SPS system. A hybrid terrestrial-satellite communication system, in contrast, operates such that the same components and component systems are used to implement communication with both the terrestrial base stations and the communication satellites.

Determining position information (pseudoranges and/or position) using the SPS system at a mobile device compatible with the hybrid terrestrial-satellite communication system may be enhanced based on the initial location and also using time and frequency information obtained from either one or both terrestrial and satellite signals. In acquiring an SPS signal, a mobile device uses its knowledge of its location and the time to search for particular satellites that should be in view from the location at the time. Depending on the uncertainty of the time and location data, using the almanac data for the particular SPS system, one or more search windows are determined. The code phase search window refers to the range of phases of the PN code expected at the receiver based on the uncertainty in the distance between the receiver and the satellite transmitting the PN code. The frequency search window can be referred to as the Doppler search window. In particular, the Doppler search window is defined by the time uncertainty or time offset and the potential frequency shift of the SPS signal caused by the Doppler effect for the satellite being acquired. A large uncertainty or offset for either time or frequency results in a larger Doppler search window, which results in a potentially longer acquisition time. By reducing the uncertainty or offset, a mobile device can reduce the Doppler search window, thereby reducing the acquisition time for SPS signals.

One method to reduce search window size is to synchronize the clock of the mobile device with the clock of the satellite. This reduces the time uncertainty component of the Doppler search window. Another method to reduce the Doppler search window is to synchronize the frequency of the mobile device with the frequency of the SPS signal. Here also, the synchronized frequency reduces the frequency uncertainty component of the Doppler search window. This synchronization is often beneficial because the oscillator error in many mobile devices is relatively high compared to the precision devices included in such satellites. In fact, the range of oscillator error in some mobile devices may even exceed the entire frequency or Doppler uncertainty range. If left unsynchronized, such a mobile device may not even be able to locate the SPS signal.

Referring back to FIG. 2, the mobile station 203 may synchronize its local oscillator using clock time and frequency measurements of the communication signals received from the communications satellite 201. In synchronizing these components of the Doppler search window, when attempting to acquire positioning signals from the positioning satellite 202, the mobile station 203 may set a relatively narrow Doppler search window, which will decrease the acquisition time.

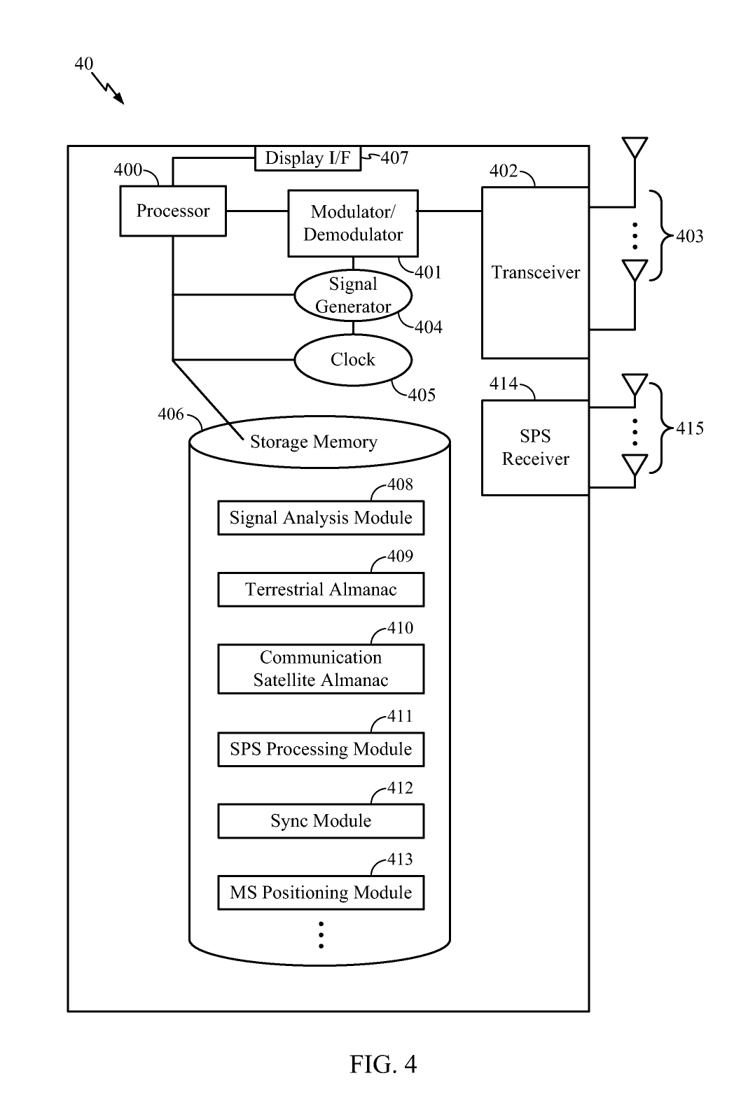

FIG. 4 is a block diagram illustrating a mobile station 40 configured according to one embodiment of the present teachings. The mobile station 40 includes many hardware components typical of a wireless mobile device, but which are specifically configured for operation in a hybrid terrestrial-satellite communication system. For example, the mobile station 40 includes a processor 400, a modulator/demodulator (modem) 401, a transceiver 402, one or more antennas; for example, an antenna array 403, a signal generator 404, a clock 405, and a storage memory 406. The mobile station 40 also includes an SPS receiver 414 with one or more antennas such as an SPS antenna array 415. These components allow the mobile station 40 to access various compatible SPS. The processor 400 controls the operations and functionality of the mobile station 40 by controlling the various hardware components and software stored on the storage memory 406. Communication signals received by the antenna array 403 are converted into operable electrical signals in the transceiver 402, demodulated in the modem 401 using signals generated by the signal generator 404 and the clock 405. Such demodulated and decoded signals may be displayed on a display screen by a display interface 407 under control of the processor 400. The antenna array 403 and transceiver 402 are configured to operate with frequencies accessible to both the terrestrial portion of the hybrid terrestrial-satellite communication system and its satellite portion, although in other embodiments multiple independent transceivers and antennas are provided.

In its positioning functionality, a mobile station positioning module 413 is stored on the storage memory 406, which, when executed by the processor 400 for obtaining the position of the mobile station 40, configures the mobile station 40 to first run a signal analysis module 408 stored on storage memory 406. The signal analysis module 408 is executed by the processor 400 and detects whether or not the mobile station 40 is in communication with one of the communication satellites of the hybrid terrestrial-satellite communication system. If so, then the executing mobile station positioning module 413 prompts access of a communication satellite almanac 410, stored on the storage memory 406. In some embodiments, the communication satellite almanac 410 includes not only conventional positioning satellite information, such as almanac and/or ephemeris data, but also includes a list of locations for each coverage area generated by the spot beams in the hybrid terrestrial-satellite communication system communication satellite antenna orientations, and the like. For example, the communication satellite information may include (for a plurality of spot beams) information indicative of a coverage area center and uncertainty as a function of time associated with an identifier of the particular spot beam. As a result of this newly added coverage area location data, the mobile station 40 determines the location of the coverage area that it is currently in, and uses that location information, along with its associated size and/or uncertainty data, to determine an initial location and uncertainty that it will use to search for SPS signals. The SPS search is controlled by execution of an SPS processing module 411, stored on the storage memory 406. The executing SPS processing module 411 activates the SPS receiver 414 and SPS antenna 415 and uses the initial location information to acquire the appropriate number of satellites in the SPS using the positioning satellite almanac and/or epehemeris data associated with the particular SPS. Once the positioning satellites have been acquired, the executing SPS processing module 411 calculates the position using the signals received from these positioning satellites. In some embodiments, pseudoranges are determined at the device and transmitted to a network resource, which calculates the position using the pseudoranges.

In order to enhance the positioning process through the SPS, the executing mobile station positioning module 413 triggers execution of a synchronization module 412, stored on the storage memory 406, by the processor 400. The executing synchronization module synchronizes the signal generator 404 with the frequency of the SPS and synchronizes the clock 405 with the time of the SPS. Typically, standard mobile devices use less expensive oscillators and frequency generators, such as the signal generator 404, which often include timing or frequency resolutions or errors that are accurate enough for proper terrestrial wireless communication, but which may have errors that would prevent the mobile device from acquiring SPS satellites. By synchronizing the clock 405 with the SPS time and training the signal generator 404 with the frequency of the SPS, the mobile station 40 is capable of more easily detecting the SPS satellite signals.

If the executing signal analysis module 408 fails to discover an adequate communication signal between the mobile station 40 and one of the communication satellites, the executing mobile station positioning module 413 directs for terrestrial positioning techniques to be used. In the embodiment illustrated in FIG. 4, the executing mobile station positioning module 413 checks the ID of the current base station that the mobile station 40 is communicating with, and, using the base station ID, looks up a known location of that base station in a terrestrial almanac 409 stored on storage memory 406. In the described embodiment, the terrestrial almanac 409 is maintained on the mobile station 40. However, it is frequently updated through connection to various base stations within the hybrid terrestrial-satellite communication system, or through any communication means that is available.

The current techniques may be implemented in a number of ways. A mobile station may determine that information about communication satellites is desired (e.g., if the mobile station does not have an adequate coarse position and/or is not in adequate communication with a terrestrial communication network). The mobile station may process received signals to determine whether it is receiving signals from a particular communication satellite (e.g., a television satellite broadcasting signals or a two-way communication satellite).

If the mobile station determines it is receiving signals from a particular communication satellite, it may access position-related information associated with the particular communication satellite. The information may indicate the coverage area of satellite communications, the center of the coverage area, indication of uncertainty of the position, and/or other indicator from which coarse position information for the mobile station may be obtained. The mobile station may use the information from the communication satellite(s) to determine a more precise position.

For example, if the mobile station determines that it is able to receive communications from a particular satellite having a particular center of coverage and a coverage radius of approximately fifty miles (the position uncertainty), the mobile station may use this information to search for positioning satellites. If the mobile station knows the current time, it can access almanac and/or other orbital information to determine which positioning satellites should be in view from the center of coverage (the assumed position of the mobile station) at the current time, as well as other information such as the expected Doppler at the current time. The extent of the search window for a particular positioning satellite can be determined based on the expected code phase of a signal received from the satellite at the center and/or edges of coverage. The size of the search window can be determined based on the position uncertainty. The mobile station can acquire the positioning satellite using the search window, then determine the pseudorange to the positioning satellite. In general, a mobile device acquires at least three positioning satellites for accurate position determination, although fewer satellites may be used if additional information is available from other sources (e.g., if terrestrial positioning can also be used) or if degraded accuracy is acceptable.

The methodologies described herein may be implemented by various components depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media; the phrase “computer-readable media” does not embrace propagating signals. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

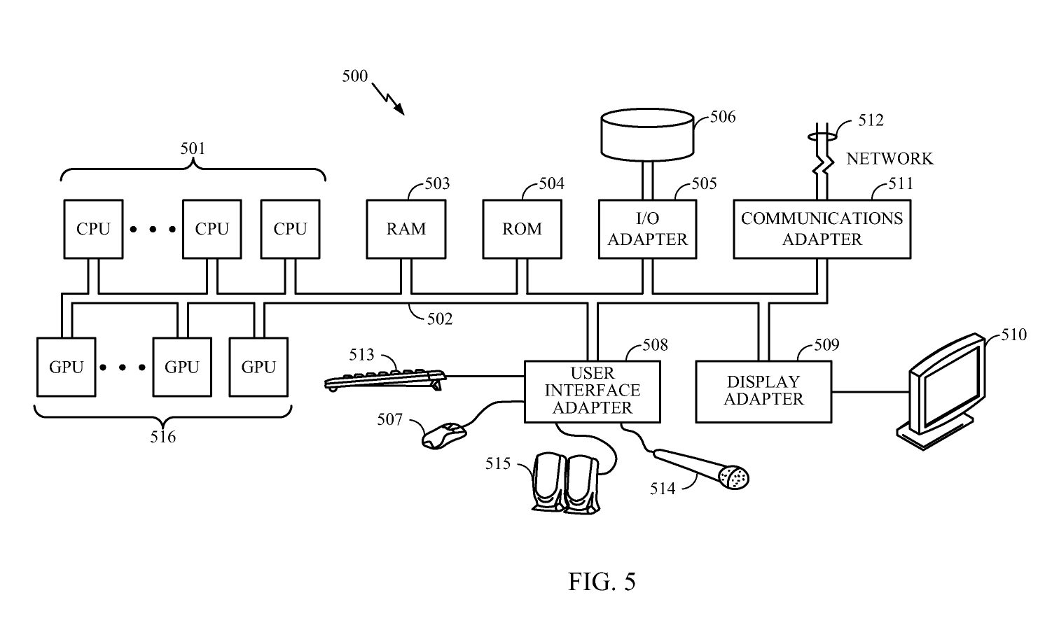

FIG. 5 illustrates an exemplary computer system 500 which may be employed to implement the base stations and their operations therein according to certain embodiments. A central processing unit (“CPU” or “processor”) 501 is coupled to a system bus 502. The CPU 501 may be any general-purpose processor. The present disclosure is not restricted by the architecture of the CPU 501 (or other components of the exemplary computer system 500) as long as the CPU 501 (and other components of the computer system 500) supports the operations as described herein. As such, the CPU 501 may provide processing to the computer system 500 through one or more processors or processor cores. The CPU 501 may execute the various logical instructions described herein. For example, the CPU 501 may execute machine-level instructions according to the exemplary operational flow described above in conjunction with FIG. 3. When executing instructions representative of the operational steps illustrated in FIG. 3, the CPU 501 becomes a special-purpose processor of a special purpose computing platform configured specifically to operate according to the various embodiments of the teachings described herein.

The computer system 500 also includes a random access memory (RAM) 503, which may be SRAM, DRAM, SDRAM, or the like. The computer system 500 includes a read-only memory (ROM) 504 which may be PROM, EPROM, EEPROM, or the like. The RAM 503 and ROM 504 hold user and system data and programs, as is well known in the art.

The computer system 500 also includes an input/output (I/O) adapter 505, a communications adapter 511, a user interface adapter 508, and a display adapter 509. The I/O adapter 505, the user interface adapter 508, and/or the communications adapter 511 may, in certain embodiments, enable a user to interact with the computer system 500 in order to input information.

The I/O adapter 505 connects to a storage device(s) 506, such as one or more of hard drive, compact disc (CD) drive, floppy disk drive, tape drive, etc., to the computer system 500. The storage devices are utilized in addition to the RAM 503 for the memory requirements associated with saving the almanacs and the like. The communications adapter 511 is adapted to couple the computer system 500 to a network 512, which may enable information to be input to and/or output from the computer system 500 via the network 512 (e.g., the Internet or other wide-area network, a local-area network, a public or private switched telephony network, a wireless network, any combination of the foregoing). A user interface adapter 508 couples user input devices, such as a keyboard 513, a pointing device 507, and a microphone 514 and/or output devices, such as speaker(s) 515 to the computer system 500. A display adapter 509 is driven by the CPU 501 or by a graphical processing unit (GPU) 516 to control the display on the display device 510. The GPU 516 may be any various number of processors dedicated to graphics processing and, as illustrated, may be made up of one or more individual graphical processors. The GPU 516 processes the graphical instructions and transmits those instructions to the display adapter 509. The display adapter 509 further transmits those instructions for transforming or manipulating the state of the various numbers of pixels used by the display device 510 to visually present the desired information to a user. Such instructions include instructions for changing state from on to off, setting a particular color, intensity, duration, or the like. Each such instruction makes up the rendering instructions that control how and what is displayed on the display device 510.

Although the foregoing description was primarily with respect to GPS, SPS also include various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present teachings. Accordingly, the appended claims are intended to include within their scope such processes, machines, manufacture, compositions of matter, means, methods, or steps.

What is claimed is:

1. A method for positioning a mobile station in a hybrid terrestrial-satellite communication system, said method comprising:
searching, at said mobile station, for a communication signal sent by at least one communication satellite of said hybrid terrestrial-satellite communication system;
determining, in response to detection of said communication signal, an initial location of said mobile station based on a location of a coverage area within which said mobile station is located, said coverage area formed by a spot beam transmitted by said at least one communication satellite;
searching, at said mobile station, for a satellite positioning system (SPS) signal using said initial location; and
determining, in response to detection of said SPS signal, information indicative of a position of said mobile station using positioning signals from said SPS signal.

2. The method of claim 1 further comprising:
determining, in response to failure of detection of said communication signal, said information indicative of said position of said mobile station using one of:
a terrestrial base station almanac including a location corresponding to each of a plurality of terrestrial base stations of said hybrid terrestrial-satellite communication system;
signal analysis of terrestrial communication signals received by at least three of said plurality of terrestrial base stations; and
determination of said positioning signals from said SPS signal, wherein said SPS signal is detected using said initial location determined by one of:
said terrestrial base station almanac; and
said signal analysis.

3. The method of claim 1 further comprising:
synchronizing said mobile station with a time and a frequency of said at least one communications satellite, wherein said searching for said SPS signal additionally uses said time and frequency synchronization and said synchronizing uses mobile and satellite position estimates.

4. The method of claim 3 wherein said synchronizing said mobile station with said frequency comprises:
training a signal generator of said mobile station using said frequency.

5. The method of claim 3 further comprising:
receiving ephemeris information regarding a source of said positioning signals; and
setting a Doppler search window based on said ephemeris information and said frequency.

6. The method of claim 1 wherein said searching for said communication signal comprises:
searching for said communication signal having a signal strength exceeding a predefined signal strength.

7. A mobile device comprising:
a processor;
a modulator/demodulator (modem) coupled to said processor;
a transceiver coupled to said processor;
an antenna array coupled to said transceiver;
a storage memory coupled to said processor;
a signal analysis module stored on said storage memory, wherein, when executed by said processor, responsive to a request for a position of said mobile device, said signal analysis module configures said mobile device to search for a communication signal from a communication satellite;
a mobile device positioning module stored on said storage memory, wherein when executed by said processor, responsive to detection of said communication signal, said mobile device positioning module configures said mobile device to access a communication satellite almanac for location information relating to a coverage area associated with said communication signal in which said mobile device is located, wherein said coverage area is formed by a spot beam transmitted from said communication satellite; and
a satellite positioning system (SPS) processing module stored on said storage memory, wherein, when executed by said processor, responsive to detection of an SPS signal using said location information, said SPS processing module configures said mobile device to determine information indicative of said position using positioning signals detected from said SPS signal.

8. The mobile device of claim 7 further comprising:
a signal generator coupled to said processor;
a clock coupled to said processor; and
a synchronization module stored on said storage memory, wherein, when executed by said processor, said synchronization module configures said mobile device to synchronize said signal generator with a frequency associated with said SPS signal and to synchronize said clock with a time associated with said SPS signal.

9. The mobile device of claim 7 further comprising:
a terrestrial almanac stored on said storage memory, wherein, when executed by said processor, responsive to failure to detect said communication signal, said mobile device positioning module further configures said mobile device to determine said information indicative of said position using base station location information stored in said terrestrial almanac, said base station location information relating to a base station in most recent communication with said mobile device.

10. A computer-readable medium including program code stored thereon, comprising:
program code, executable at a mobile station, to search for a communication signal from at least one communication satellite of a hybrid terrestrial-satellite communication system;
program code, executable responsive to detection of said communication signal, to determine an initial location of said mobile station based on a location of a coverage area within which said mobile station is located, said coverage area created by a spot beam transmitted from said at least one communication satellite;
program code, executable at said mobile station, to search for a satellite positioning system (SPS) signal using said initial location; and
program code, executable in response to detection of said SPS signal, to determine information indicative of a position of said mobile station using positioning signals from said SPS signal.

11. The computer-readable medium of claim 10 further comprising:
program code, executable responsive to failure of detection of said communication signal, to determine said position of said mobile station using one of:
program code to access a terrestrial base station almanac including a location corresponding to each of a plurality of terrestrial base stations of said hybrid terrestrial-satellite communication system;
program code to analyze terrestrial communication signals received by at least three of said plurality of terrestrial base stations; and
program code to determine information indicative of said positioning signals from said SPS signal, wherein said SPS signal is accessed using said initial location determined by one of:
said terrestrial base station almanac; and
said program code to analyze.

12. The computer-readable medium of claim 10 further comprising:
program code to synchronize said mobile station with a time and a frequency of said SPS signal, wherein said program code to access additionally uses said time.

13. The computer-readable medium of claim 12 wherein said program code to synchronize said mobile station with said frequency comprises:
program code to train a signal generator of said mobile station using said frequency.

14. The computer-readable medium of claim 12 further comprising:
program code to receive ephemeris information regarding a source of said positioning signals from said SPS signal; and
program code to set a Doppler search window based on said ephemeris information and said frequency.

15. The computer-readable medium of claim 10 further comprises:
program code to search for said communication signal having a signal strength exceeding a predefined signal strength.

16. A system for positioning a mobile station in a hybrid terrestrial-satellite communication system, said system comprising:
means, executable at said mobile station, for searching for a communication signal from least one communication satellite of said hybrid terrestrial-satellite communication system;
means, executable responsive to detection of said communication signal, for determining an initial location of said mobile station based on a location of a coverage area within which said mobile station is located, said coverage area created by a spot beam transmitted from said at least one communication satellite;
means, executable at said mobile station, for searching for a satellite positioning system (SPS) signal using said initial location; and
means, executable in response to detection of said SPS signal, for determining information indicative of a position of said mobile station using positioning signals from said SPS signal.

17. The system of claim 16 further comprising:
means, executable responsive to failure of detection of said communication signal, for determining said position of said mobile station using one of:
an almanac including a location corresponding to each of a plurality of terrestrial base stations of said hybrid terrestrial-satellite communication system;
signal analysis of terrestrial communication signals received by at least three of said plurality of terrestrial base stations; and
determination of said positioning signals from said SPS signal, wherein said SPS signal is accessed using said initial location determined by one of:
said almanac; and
said signal analysis.

18. The system of claim 16 further comprising:
means for synchronizing said mobile station with a time and a frequency of said SPS, said accessing means additionally using said time.

19. The system of claim 18 wherein said means for synchronizing said mobile station with said frequency comprises:
means for training a signal generator of said mobile station using said frequency.

20. The system of claim 18 further comprising:
means for receiving ephemeris information regarding a source of said positioning signals; and
means for setting a Doppler search window based on said ephemeris information and said frequency.
